(19) United States
(12) Patent Application Publication
(10) Pub. No.: US 2021/0365555 A1
(43) Pub. Date: Nov. 25, 2021

(54) A METHOD AND SYSTEM FOR DETECTING AND PREVENTING ISSUES IN SMART CONTRACTS BASED ON HISTORICAL BEHAVIOR ANALYSIS

(71) Applicant: VALID NETWORK LTD, Beer Sheva (IL)

(72) Inventors: Kfir NISSAN, Haifa (IL); Gilad EISENBERGER, Haifa (IL)

(73) Assignee: VALID NETWORK LTD, Beer Sheva (IL)

(21) Appl. No.: 16/977,726

(22) PCT Filed: Mar. 18, 2019
(86) PCT No.: PCT/IL2019/050296

§ 371 Date: Sep. 2, 2020

Related U.S. Application Data
(60) Provisional application No. 62/644,521, filed on Mar. 18, 2018.

(51) Int. Cl. G06F 21/56; G06F 21/55; G06F 21/60; G06F 21/64; G06F 9/30

(52) U.S. Cl. CPC G06F 21/563; G06F 21/554; G06F 9/30181; G06F 21/64; G06F 21/602

(57) ABSTRACT

The present invention relates to a system and a method which receives as an input transactions and a smart contract code, and provides as an output an analysis of possible issues such as possible security attacks or bugs found in the smart contract code that may exist in the smart contract code that was input to the blockchain-based system. More specifically, the present invention relates to the way data is stored in decentralized systems such as blockchain-based systems, to identify base paths and then alters the base paths looking for an attack, in a guided way.

### FIELD OF THE INVENTION

The invention relates to the field of computer-assisted testing of a smart contract. More specifically the invention relates to a method and system for detecting and preventing security issues in smart contracts based on historical behavior analysis.

### BACKGROUND OF THE INVENTION

A smart contract is a computer code running on top of a decentralized system such as blockchain, containing a set of rules under which the parties to that smart contract agree to interact with each other. If and when the pre-defined rules are met, the agreement is automatically enforced. The smart contract code facilitates, verifies, and enforces the negotiation or performance of an agreement or transaction. It is the simplest form of decentralized automation. Actually, in a smart contract a decentralized ledger of the decentralized system is used and results in ledger feedback such as transferring money and receiving the product or service.

For example, in some aspects, a smart contract is a mechanism that may involve digital assets and two or more parties, where some or all of the parties deposit assets into the smart contract and the assets automatically get redistributed among those parties according to a formula based on certain data, which is not known at the time of contract initiation.

However, a major disadvantage of the smart contracts are the fact that once it is used (i.e., deployed into the decentralized system), it cannot be changed, and if there are some aspects that are not taken into account when coding the smart contract, these aspects remains untreated. Moreover, if there was a mistake or bug in the code of the smart contract, it is impossible to change the code and to execute a benign code of the smart contract.

It is therefore an object of the present invention to provide an automated system which enable to detect potential security issues in smart contracts before they are used within the decentralized system.

It is another object of the present invention to provide a system and method which simulates a specific attack that utilizes the vulnerability of the smart contract and assess its impact if used, before it is used within the decentralized system.

Other objects and advantages of the present invention will be described as the description proceeds.

### SUMMARY OF THE INVENTION

The present invention is a system for predicting and finding issues in a smart contract code based on historical behavior of said smart contract, comprising:
a base paths detector module, which receives a list of past transaction and a smart contract code and accordingly detects at least one base path which are baseline flows through said smart contract code that indicate how the blockchain-based system worked in the past;
an attack simulator module, which receives a detected base path from said base paths detector module, selects one or more attack to simulate for said detected base path, and outputs data relative to said selected one or more attacks along with an intended baseline path; and
a back tracking and impact analysis module which evaluates what input could cause a potential issue in said smart contract code in accordance with a specific instruction when running a transaction that was used as the base path, analyzes the potential impact of such a potential issue, and outputs a predicted list of issues in accordance with deviation in said smart contract code.

According to an embodiment of the invention, the attack simulator module is attempting to change real-world operation of the detected base path in a way that would cause the attack.

According to an embodiment of the invention, the one or more attacks are selected from a set of known possible attacks that are relevant to each specific baseline path, wherein each attack simulation selects a single executed instruction whose behavior is to be altered.

According to an embodiment of the invention, the list of past transactions is retrieved from a ledger of a blockchain-based system.

According to an embodiment of the invention, the base path comprising an ordered list of instructions that were executed together with the data used in said instructions.

In another aspect, the present invention relates to a method for predicting and finding issues in a smart contract code based on historical behavior of said smart contract, comprising the steps of:
receiving a list of past transactions and a smart contract code for detecting at least one base path in said smart contract code;
simulating one or more attacks for each detected base path;
evaluating an input data that may cause a potential issue in said smart contract code in accordance with a specific instruction of said smart contract code when running the actual transaction used with the detected base path; and
analyzing an impact of said potential issue and outputting a corresponding alert.

According to an embodiment of the invention, the simulating is attempting to change real-world operation of the detected base path in a way that would cause the attack.

According to an embodiment of the invention, the one or more attacks are selected from a set of known possible attacks that are relevant to each specific baseline path, wherein each attack simulation selects a single executed instruction whose behavior is to be altered.

In yet another aspect, the present invention is an apparatus, comprising:
a device including at least one memory adapted to store run-time data for the device, and at least one processor that is adapted to execute processor-executable code that, in response to execution, enables the device to perform actions, including:
   retrieving from a list of past transaction and a smart contract code;
   detecting one or more base paths which are baseline flows through said smart contract code that indicate how the blockchain-based system worked in the past;
   simulating one or more attacks for each detected base path;
   evaluating an input data that may cause a potential issue in said smart contract code in accordance with a specific instruction of said smart contract code when running the actual transaction used with the detected base path; and
   analyzing an impact of said potential issue and outputting a corresponding alert.

In another aspect, the present invention is a processor-readable storage medium, having stored thereon process-executable code that, upon execution by at least one processor, enables actions, comprising:
receiving a list of past transactions and a smart contract code;
detecting at least one base path in said smart contract code;
simulating one or more attacks for each detected base path;
evaluating an input data that may cause a potential issue in said smart contract code in accordance with a specific instruction of said smart contract code when running the actual transaction used with the detected base path; and
analyzing an impact of said potential issue and outputting a corresponding alert.

### BRIEF DESCRIPTION OF THE DRAWINGS

FIG. 1 schematically shows a block diagram describing the system of the present invention according to an embodiment of the invention;

FIG. 2 schematically shows a flowchart describing the method of the present invention according to an embodiment of the invention; and

FIG. 3 schematically shows an example for the tracking back and impact analysis steps of the present invention according to an embodiment of the invention.

### DETAILED DESCRIPTION OF THE EMBODIMENTS OF THE INVENTION

The present invention related to decentralized systems. For the sake of convenience, the description will relate to a blockchain-based system as an example for decentralized system. However, the invention is not limited to blockchain-based system only, but relates to any decentralized system.

The present invention relates to a system and a method which receives as an input transactions and a smart contract code, and provides as an output an analysis of possible issues such as possible security attacks or bugs found in the smart contract code that may exist in the smart contract code that was input to the blockchain-based system. More specifically, the present invention relates to the way data is stored in decentralized systems such as blockchain-based systems, to identify base paths and then alters the base paths looking for an attack, in a guided way.

The term base path refers herein to the input data used to run the function of the smart contract, and which instructions were executed and what values were involved in the instructions. The blockchain-based system keeps a ledger of all executed transactions as a mechanism to verify the correctness of its current state. When a new server needs to sync with the blockchain, it can rerun all the transactions to arrive at the current state. According to an embodiment of the present invention, the system of the present invention utilizes this data, the ledger, to rerun transactions that occurred in the past, to use them as base paths for the analysis. When a transaction is rerun, all the input data, the instructions that were executed and what data was involved in the instructions are logged. This forms the base path for the following steps of the evaluation as performed by the system and method of the present invention.

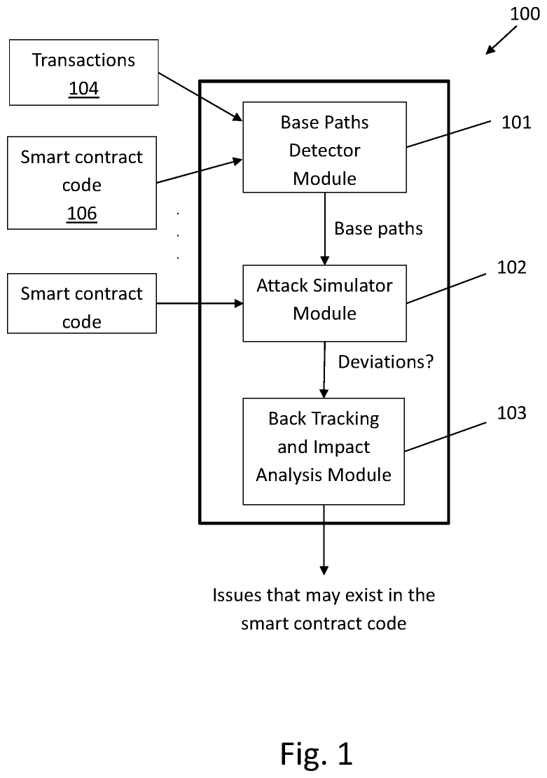

FIG. 1 schematically shows a block diagram describing a system 100 for detecting and preventing security issues in smart contracts, according to an embodiment of the present invention. System 100 comprises a base paths detector module 101, an attack simulator 102 and a back tracking and impact analysis module 103.

System 100 may receive two main inputs as indicated by numerals 105 and 106 (e.g., that can be inserted by a user). The first input is a log of transactions 105 that were executed on the blockchain-based system in the past (or on any other decentralized system). For example, the log of transactions can be retrieved from the ledger of the blockchain-based system, or it can be taken from any other location suitable to provide the transactions data. The second input is a smart contract code 106 needed to be tested. The smart contract code 106 can be taken from the ledger of the blockchain-based system or from other sources, such as source code provided by the user of the system. The final output of system 100 is a predicted list of issues that may exist in the smart contract code inputted to the system. The issues may be security oriented issues such as possible attacks or other problems and vulnerabilities of the smart contract code that were not considered by the developer of the code. A main advantage of the invention is that although the smart contract has already been deployed and used, system 100 may find vulnerabilities that have not yet been exploited, thereby enabling the author of the code or other authorized user to update the code of the smart contract in order to overcome any detected vulnerabilities that have not yet been exploited. The output list of system 100 may comprise a predicted list of new issues that were not exploited in the executed transactions, based on the analysis of the historical behavior of the executed transactions.

Base paths detector module 101 receives the two main input of system 100, i.e. the log of transactions and the smart contract code. The base paths detector module 101, detects base paths, which are baseline flows through the code of the smart contract that are how the blockchain-based system worked in the past. A baseline path consists of an ordered list of instructions that were executed, and the data used in these instructions. The output of the base path detector module 101 is a set of baseline paths, which are provided as an input to the attack simulator module 102. The attack simulator module 102 selects for a specific base path, an attack to simulate, attempting to change the real-world operation of the selected base path, in a way that would cause the attack. Module 102 selects from a set of known possible attacks that are relevant to each baseline path, one or more attacks to simulate. An attack would possibly select a single executed instruction whose behavior is to be altered, such as an arithmetic operation that should be overflown. This module 102 outputs the details of the above attack, along with the intended baseline path, which is used as the input to the next module, the back tracking and impact analysis module 103. Module 103 evaluates what input could cause the potential attack selected by module 102 in the specific instruction of the smart contract code when running the transaction used as the base path. To do so, module 103 could iterate, in reverse order, over the instructions of the baseline path, from the selected attack instruction back to the start of the transaction. This reverse iteration allows the module 103 to determine which inputs, if any, could cause the attack to occur. Then, module 103 analyzes the potential impact of such an attempted attack or issue. To do so, the module 103 could, for example, utilize the inputs determined after iterating in reverse order, to simulate a possible attack against the smart contract, determining the impact of such a transaction with these determined inputs.

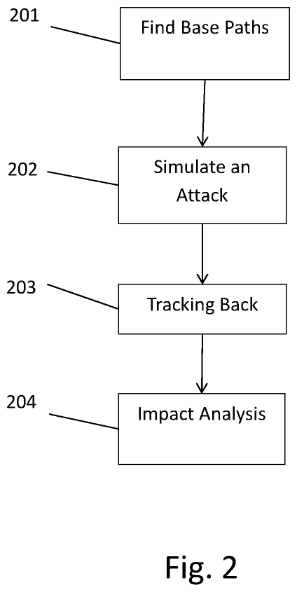

FIG. 2 schematically shows a flowchart describing the method for detecting and preventing security issues in smart contracts, according to an embodiment of the present invention.

In the first step 201, system 100 identifies the base paths. Such step is important, because the base path represents actual code that was run through the blockchain-based system with real-world data. This means any attack found by system 100 would not be a theoretical attack that might never happen, but rather a possible attack that could have happened. For example, if a blockchain-based system had a flag that removed all security features, but no one ever used that, using real-world data would ensure the system of the present invention does not alert on possible attacks that could happen if the customer were to turn off security.

As an example, we could look at the following “send” function that can be part of a smart contract code:

function send(address[ ] _receivers, int _value) {

int cnt = _receivers.length;
int amount = cnt * _value;
require(balances[msg.sender] >= amount);
// ...

}

This function sends several people a certain amount of funds. Before sending, it naturally verifies the sender has sufficient funds.

A base path through this function might be “send([A, B], 100)”, that would send two addresses, A and B, 100 tokens each. This transaction could have succeeded, for example, as the sender had sufficient funds.

The second step 202 simulates an attack. Once a base path is selected from the available identified base paths, system 100 selects an attack to simulate, attempting to change the real-world operation that caused the base path in a way that would cause the attack.

System 100 selects from a library of possible attack vectors to use. Some examples of such attacks could be integer overflow, buffer overflow/underrun, reentrancy, etc. System 100 then identifies a location in the identified base path where the attack could happen. For example, system 100 might select an arithmetic add operation and select that as the location where an integer overflow should occur. Additional examples could include selecting a memory access instruction as the location of a buffer overflow or underflow attack, or selecting an instruction that invokes another contract as the location of a possible reentrancy attack.

The next steps 203, is a tracking back process. In this step, system 100 finds out more details what inputs could have caused an attack, such as an integer overflow in an instruction, at the time the transaction was executed, with the data that was active when it was executed (the tracking back process will be described with more details hereinafter). If a possible input was detected, system 100 evaluates the impact of such an attack in step 204 of impact analysis, by analyzing the detected input by executing a simulated transaction with this input, and determining the effects of such a transaction. The impact analysis step 204 is important since in many cases, smart contracts have protection against attacks located after the vulnerable instruction, which negate the possibility of attack. The impact analysis step 204 verifies the detected attack vector can be used and is not negated in an instruction after the vulnerable instruction.

In order to better understand the tracking back process, we refer now back to the example of the “send” function as described hereinabove, where system 100 could, for example, look for an overflow in a selected instruction such as a multiplication operation:

int amount=cnt*_value;

Accordingly, in step 203, system 100 may evaluate what input could cause an integer overflow in the specific instruction when running the transaction used as the base path.

To do so, system 100 starts working back along the base path, from the selected instruction back to the start of the transaction. While tracking back through the instructions, the system 100 maintains a record of what values need to be in what variables to cause the desired overflow.

Continuing with the integer overflow in the “send” function, the pseudo operation of tracking back would look like:

int amount=cnt*_value; =>cnt*_value>MAX_INT

int cnt=_receivers.length; =>_receivers.length*_value>MAX_INT

Once the third step 203 of the tracking back process is finished, the set of conditions that could cause an overflow is left. In many cases this set of conditions might be empty—or impossible to fulfill—mostly when sufficient input verification is performed to block the overflow attack for this case.

In the case above, the conditions can be easily satisfied, by passing the same receivers as in the base path, and changing the input of “_value” to be more than “MAX_INT/2”. This means that system 100 is able to identify a set of inputs that would have caused the selected instruction to cause an overflow, had the transaction been executed with those values instead of the ones that were actually used.

The same logic could be applied to a buffer overrun/underrun or even reentrancy (reentrancy will be discussed in further details hereinafter).

The fact that system 100 identified a way to cause the selected instruction to overflow is a good indication that we found an issue, but we still need to see what the impact of this overflow is.

In the fourth step 204, once system 100 identified a set of inputs that might cause a security issue (e.g., since they cause an overflow or other problematic state when run in at least one case), system 100 analyzes the potential impact of such an attempted attack. To do this, the system 100 simulates the execution of the transaction with the identified inputs at the original time the base path had executed. During this simulation the transaction will follow the base path until the selected instruction, where it will overflow as planned. From this point, system 100 will continue executing the transaction to completion, and accordingly analyze the impact of the transaction.

There are many ways to determine the impact of the attack, however, we would likely want the transaction to fail if there was an overflow, and undo all changes it made. Assuming the analysis showed the transaction would not have failed if executed, we might want to determine this is a potential security issue.

Another way to assess the impact would be to test the transactions' results against a set of rules of how the blockchain-based system is expected to behave. If the transaction causes the blockchain-based system to break on of these rules, it would be reasonable to flag this as a potential attack vector.

By this point, system 100 identified a potential attack vector that could have been utilized in the past. This would generally point towards a problem with the smart contract being tested.

Utilizing a base path allows system 100 to focus on real-world state of the blockchain-based system. When comparing to traditional symbolic analysis of a piece of code—symbolic analysis would need to focus on any possible state of the blockchain-based system, rather than focusing on the real world state it is in.

By using the base path, the testing refers to a real-world past state, and therefore it can determine when the attack would have been successful had it been performed. This makes detected vulnerabilities much more relevant to real world use.

In an embodiment of the invention, testing for reentrancy is a different implementation of the same concept. Here, instead of looking for how an instruction might overflow, the system 100 looks for what might execute while an instruction is running. For most instructions, at least on blockchain-based systems, nothing can run during an instruction such as add or multiply. However, when a call instruction is performed, the code is running in another contract. That code can call the original contract in return and cause code in the current contract to execute while the call instruction is still executing. This is reentrancy, as the contract (via a public function) is re-entered, while it is in the middle of running code.

The system of the present invention, can detect call instructions (or other instructions that can allow for reentrancy) and assess the possible impact of running a transaction during execution. In this case, system 100 treats any such instruction as a potential attack and performs the impact analysis (of step 204) to cause invalid behavior when the blockchain-based system is in this mid-execution step. This allows identifying reentrancy issues that would be difficult to identify otherwise.

This solution effectively may detect vulnerable states the blockchain-based system was in, in the past, and accordingly can generate an alert or report in order to overcome such detected vulnerable states.

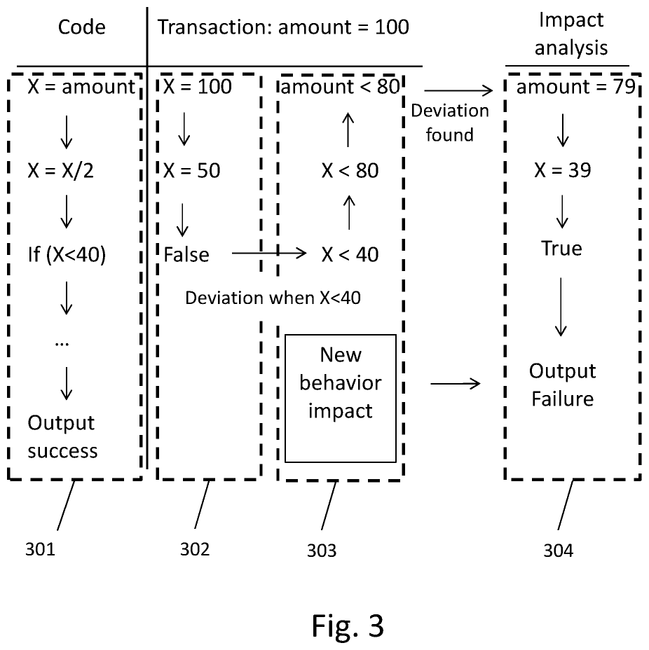

FIG. 3 schematically shows an example for the back tracking and impact analysis steps, according to an embodiment of the present invention. In the figure, the leftmost column 301 shows a possible contract's source code where X represent an input transaction amount, and according to this specific code X is divided by 2 (i.e., X=X/2) and then it checks whether the result is less than 40 (i.e., X<40) in order to enable the transaction (i.e., output success). The second-leftmost column 302 shows the base path through this source code (in this example X=100, and therefore the result of X/2 is more than 40). The second-rightmost column 303 shows the back tracking phase, from bottom to top (as indicated by the direction of the arrows in this column), to determine which input could cause the selected deviation in the code's behavior (according to this example the “new behavior impact” occurs when the amount is less than 80). The rightmost column 304 shows the impact analysis phase, from top to bottom (as indicated by the direction of the arrows in this column), where the identified attack input (e.g., amount=79) is simulated to determine the possible impact of the detected attack vector when the input amount is less than 80, than it refers to “output failure”.

1. A system for predicting and finding issues in a smart contract code based on historical behavior of said smart contract, comprising:
a) a base paths detector module, which receives a list of past transaction and a smart contract code and accordingly detects at least one base path which are baseline flows through said smart contract code that indicate how the blockchain-based system worked in the past, wherein each baseline consists of an ordered list of instructions that were executed and the data used in these instructions;
b) an attack simulator module, which receives a detected base path from said base paths detector module, selects one or more attack to simulate for said detected base path, and outputs data relative to said selected one or more attacks along with an intended baseline path; and
c) a back tracking and impact analysis module which evaluates what input could cause a potential issue in said smart contract code in accordance with a specific instruction when running a transaction that was used as the base path, analyzes the potential impact of such a potential issue, and outputs a predicted list of issues in accordance with deviation in said smart contract code.

2. A system according to claim 1, wherein the attack comprises an executed instruction whose behavior is to be altered.

3. A system according to claim 1, wherein the one or more attacks are selected from a set of known possible attacks that are relevant to each specific baseline flow, wherein each attack simulation selects a single executed instruction whose behavior is to be altered.

4. A system according to claim 1, wherein the list of past transactions are retrieved from a ledger of a blockchain-based system.

5. (canceled)

6. A method for predicting and finding issues in a smart contract code based on historical behavior of said smart contract, comprising the steps of:
a) receiving a list of past transactions and a smart contract code for detecting at least one base path in said smart contract code, wherein each detected base path comprises an ordered list of instructions that were executed and the data used in said instructions;
b) simulating at least one attack for a detected base path that attempts to change the real-world operation of the selected base path that caused said base path, in a way that would cause said attack and outputting data relative to said attack along with said detected base path;
c) evaluating an input data that may cause a potential issue in said smart contract code in accordance with said attack when running a transaction used with the detected base path; and
d) analyzing an impact of said potential issue and outputting a corresponding alert.

7. A method according to claim 5, wherein the simulating comprising an executed instruction whose behavior is to be altered.

8. A method according to claim 5, wherein the one or more attacks are selected from a set of known possible attacks that are relevant to each specific baseline flow, wherein each attack simulation selects a single executed instruction whose behavior is to be altered.

9. (canceled)

10. A processor-readable storage medium, having stored thereon process-executable code that, upon execution by at least one processor, enables actions, comprising: receiving a list of past transactions and a smart contract code;
detecting at least one base path in said smart contract code, wherein each detected base path comprises an ordered list of instructions that were executed and the data used in said instructions;
simulating one or more attacks for each detected base path that attempts to change the real-world operation of the selected base path that caused said base path, in a way that would cause said attack, and outputting data relative to said attack along with said detected base path;
evaluating an input data that may cause a potential issue in said smart contract code in accordance with said attack while using a specific instruction whose behavior is to be altered when running a past transaction used with the detected base path; and analyzing an impact of said potential issue and outputting a corresponding alert.
